(19) United States
(12) Patent Application Publication
(10) Pub. No.: US 2026/0249644 A1
(43) Pub. Date: Aug. 27, 2026

(54) Single Pod Differential Swerve Drive System

(71) Applicant: Cardinal Gibbons High School, Raleigh, NC (US)

(72) Inventors: William Thomas Degele, Raleigh, NC (US); Wyatt John Nicholson, Cary, NC (US); Savannah Rose Dowdall, Chapel Hill, NC (US); Milo Marius Mika, Wake Forest, NC (US); Scott William Gilbert, Raleigh, NC (US); Joseph Philip Swain, Raleigh, NC (US); Jacob Anthony Vazquez, Raleigh, NC (US); Anna Jane Greene, Raleigh, NC (US); Kayla Patricia Martin, Apex, NC (US); William Charles Holt, Raleigh, NC (US)

(21) Appl. No.: 19/432,399

(22) Filed: Dec. 24, 2025

(51) Int. Cl. B60B 19/00; B25J 5/00; B60K 1/02; B62D 9/00; B62D 61/06; G05D 1/245; G05D 109/18

(52) U.S. Cl. CPC B60B 19/003; B25J 5/007; B60K 1/02; B62D 9/00; B62D 61/06; G05D 1/245; G05D 2109/18

(57) ABSTRACT

A robotic vehicle includes an omni-directional drive system having a single centrally mounted differential swerve pod with a traction wheel steerable to substantially any azimuth. First and second electric motors drive cooperative gear trains that, through differential operation, selectively rotate the pod housing for steering and rotate the traction wheel for propulsion, including coordinating their actions to provide simultaneous steering and propulsion. Chassis stability is provided by support elements spaced from the traction wheel, including laterally positioned omni-wheels and additional chassis support points, enabling constrained pitch and roll while permitting unrestricted yaw. In some embodiments, the omni-wheels are driven by continuous-rotation servos through a clutch to provide controllable chassis yaw. A controller uses encoder feedback to coordinate wheel steering, propulsion, and field-oriented motion.

### FIELD OF THE INVENTION

The subject matter described herein relates to a novel robot with a single-pod differential swerve drive system. The robot is further equipped with a compact linear slide. This robot may have a particular but not exclusive utility for education, construction, and manufacturing.

### BACKGROUND

The present invention relates generally to mobile robotic systems and, more specifically, to improvements in wheel-based drive mechanisms that enhance traction, maneuverability, and mechanical robustness.

One known robotic drive system is described in U.S. Pat. No. 8,794,386, which describes a robot equipped with a low-profile base that is movable in a generally horizontal direction. The robot's drive system incorporates a conventional skid-steer chassis driven by paired DC gearmotors acting through rubber-tired wheels on each side. Skid steering simplifies construction yet imposes two familiar limitations. First, turning requires differential wheel slip, so the robot's rubber-tired wheels are necessarily selected to have limited traction. Second, precise odometry is difficult because lateral slip is unmeasured. These restrictions limit the platform's usefulness when accurate navigation or high traction is critical.

Additional robotic drive systems are described in U.S. Pat. Nos. 9,211,922 and 10,384,338, which describe robots employing four compliant treaded wheels made up of interlinked elastomeric plates wrapped around sprocketed wheel discs. The plates conform to small obstacles and distribute load, giving better grip than smooth tires. Nevertheless, the design requires a relatively large overall wheel diameter, raising the frame and the center of gravity without a commensurate gain in lateral stability. Finally, steering remains skid-based, so the earlier concerns about limited traction and odometric drift persist.

A unique robotic drive system is described in U.S. Pat. No. 10,647,351, which describes a robot with wheels machined with peripheral scallops sized to hook onto ladder rungs or similar discrete features. The left-and right-side wheels can be re-indexed by a virtual differential so that opposed scallops align with the same rung. On flat ground the wheels behave almost like ordinary tires, but on stepped or caged surfaces the scallops generate positive mechanical interlock. Although the approach markedly increases obstacle-climbing capacity, it does so at the cost of continuous rolling contact. When the scallops are not engaged the wheel alternates between bite and free-roll, producing vibration that limits top speed and complicates closed-loop position control. The virtual differential itself is electronic, not mechanical, so the system still relies on skid turns and retains the tractive power penalty noted above.

The present robot addresses those shortcomings with a novel drive system that combines high maneuverability, high traction, and high-speed while retaining packaging flexibility.

### BRIEF DESCRIPTION OF THE DRAWINGS

FIG. 1a is a perspective view of an exemplary robot embodying some principles of the present invention. FIGS. 1b-1d are, respectively, side, bottom, and front views of the robot illustrated in FIG. 1a.

FIG. 2A is a front view of an example embodiment of a swerve pod. FIGS. 2B-2C are, respectively, top and side views of the swerve pod illustrated in FIG. 2A.

FIG. 3 is an exploded perspective view of selected components of an embodiment of a swerve pod.

FIG. 4 is an exploded perspective view of selected components of an embodiment of a swerve pod.

FIG. 5 is an exploded perspective view of selected components of an embodiment of an omni-wheel subsystem.

FIG. 6 is an exploded perspective view of selected components of an embodiment of an omni-wheel subsystem.

FIG. 7 is a bottom view of selected components of an embodiment of a swerve pod.

FIG. 8 is a perspective view of an embodiment of a pod housing.

FIG. 9A is a perspective view of selected components of an embodiment of an omni-wheel subsystem. FIG. 9B is an exploded perspective view of an embodiment of an omni-wheel subsystem.

FIG. 10A is a front view of selected components of an embodiment of a ladder-lift subassembly. FIG. 10B is a side view of the subsystem illustrated in FIG. 10A.

FIGS. 11A and 11B are top and side views, respectively, of an embodiment of an extended set of slide stages.

FIG. 12 is an exploded perspective view of selected components of an embodiment of slide stages.

FIG. 13 is a partly exploded perspective view of selected components of an embodiment of a continuous string slides subassembly.

FIG. 14 is an exploded perspective view of one embodiment of a string tensioning insert.

FIG. 15 is an exploded perspective view of one embodiment of an insert block.

FIG. 16 is an exploded perspective view of selected components of one embodiment of a driving spool subassembly.

FIG. 17 is a perspective view of selected components of an embodiment of a pivot base subassembly.

FIG. 18 is a perspective view of selected components of an embodiment of a robot cover.

FIG. 19 illustrates an exemplary method to control the rotation of an omni-wheel servo.

FIG. 20 illustrates an exemplary method to control the engagement of an omni-wheel servo.

FIG. 21 illustrates an exemplary method to process an image input.

FIG. 22 illustrates an exemplary method to process an image input.

FIG. 23 illustrates a perspective view of an exemplary robot embodying some principles of the present invention.

FIG. 24 illustrates a perspective view of selected components of an embodiment of a claw arm.

FIG. 25 illustrates a perspective view of selected components of an embodiment of a ladder-lift subassembly.

FIG. 26 illustrates a perspective view of embodiment of an insert block.

FIG. 27A is an exploded perspective view of selected components of one embodiment of a swerve drive pod. FIG. 27B is an exploded front view of the components illustrated in FIG. 27A.

### DETAILED DESCRIPTION

For ease of understanding, reference is made herein to the accompanying figures. Identical reference numerals designate identical or functionally equivalent elements throughout the drawings. All dimensional relationships are exemplary and may be varied without departing from the scope of the inventive concepts described.

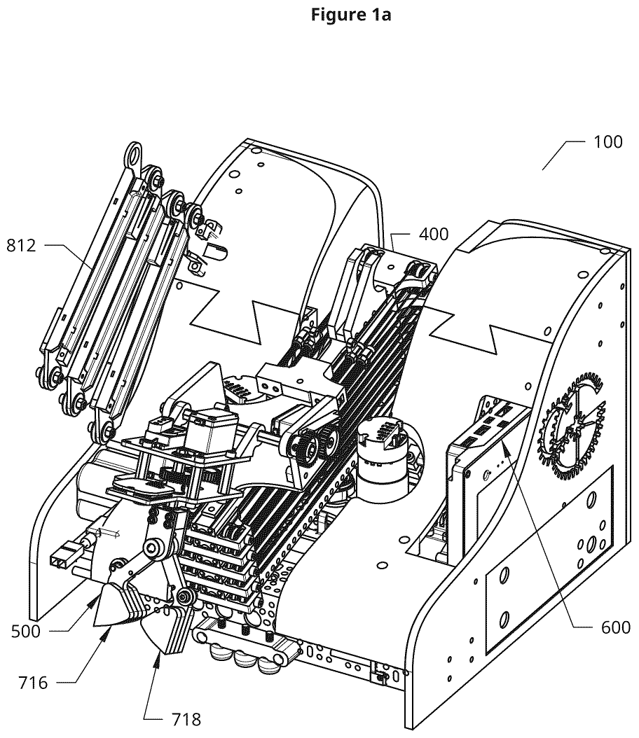

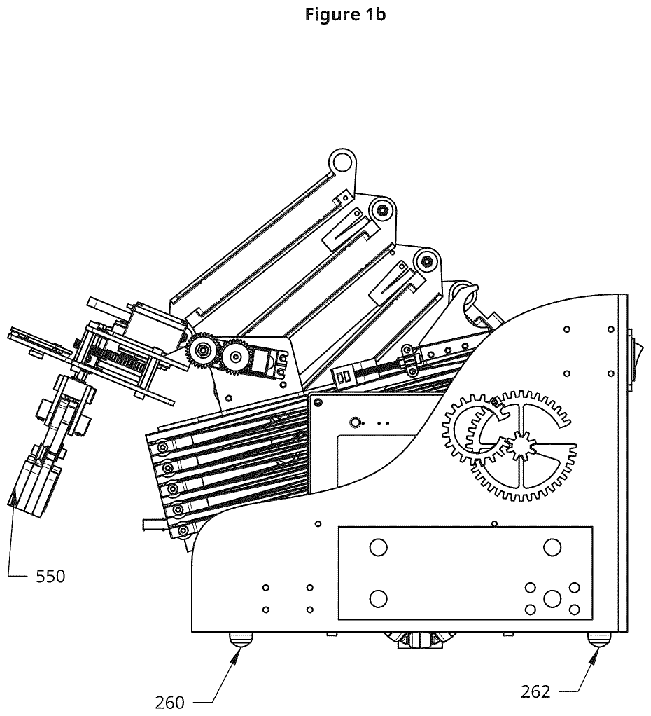

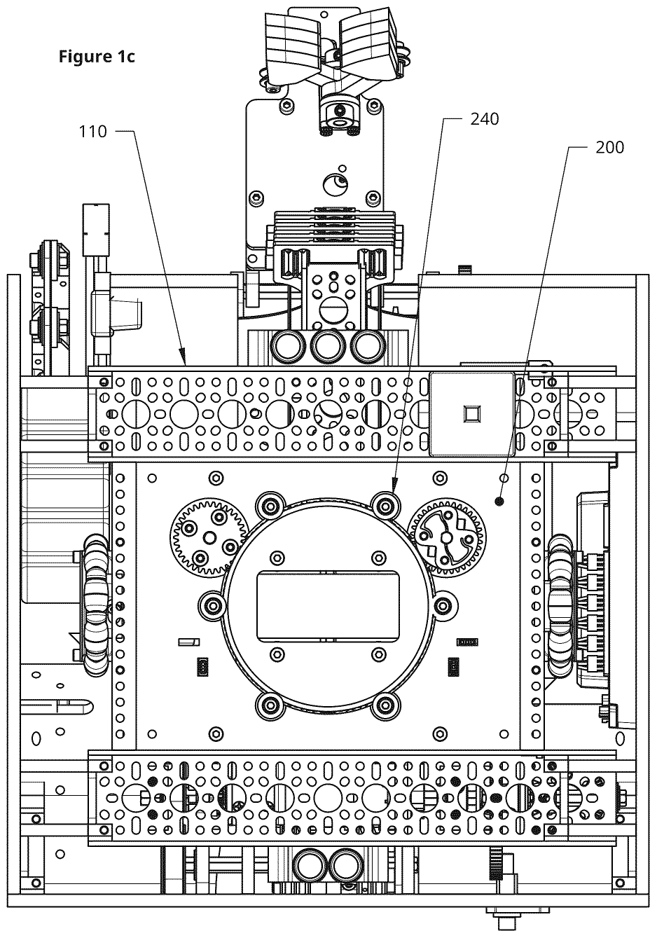

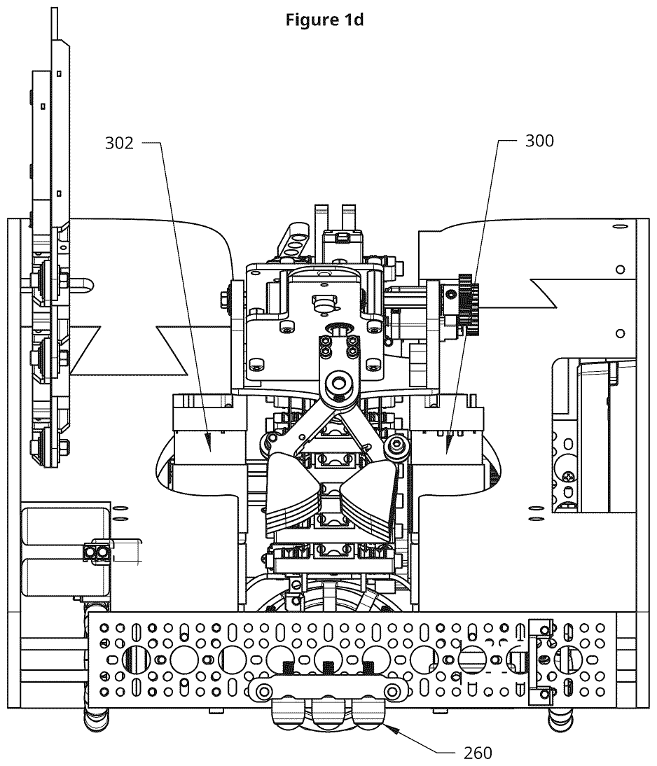

FIG. 1A shows a perspective view of an example embodiment of a robot 100 constructed in accordance with the present disclosure. Additional details of the robot 100 are further illustrated in FIGS. 1B-1D. The robot comprises a chassis 110, a swerve pod 200 centrally mounted to the chassis, a pair of servo-driven omni-wheel assemblies 300, 302 located on opposite lateral sides of the swerve pod, an omni-wheel disengagement clutch, a vertical ladder-lift slide subsystem 400, an articulated arm and wrist assembly 500 coupled to the slide subsystem, a claw end 550, and a control hub 600.

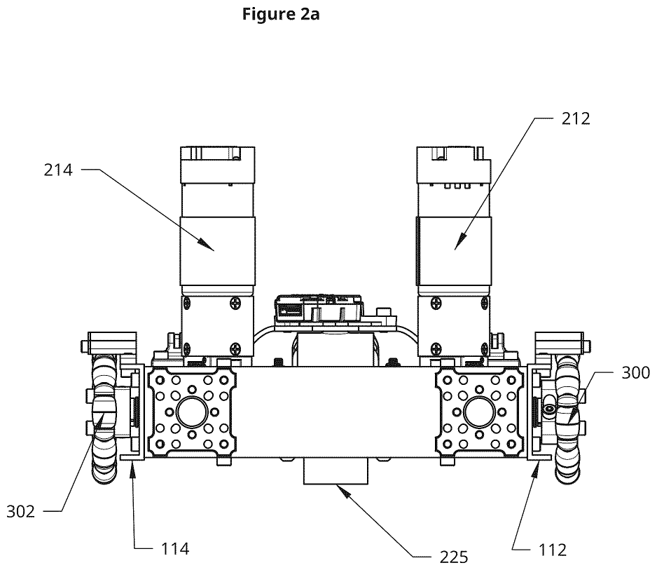

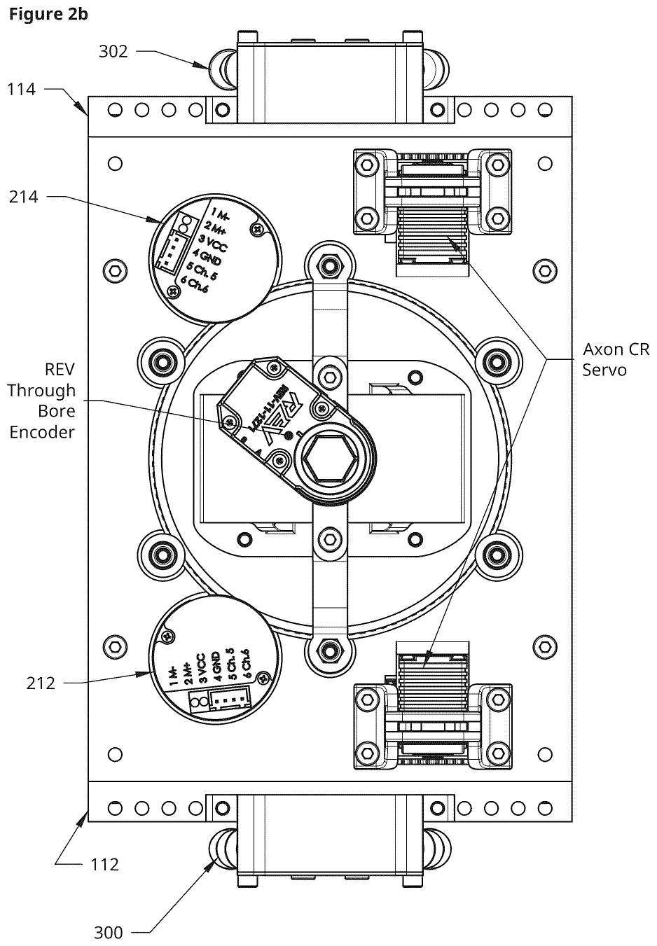

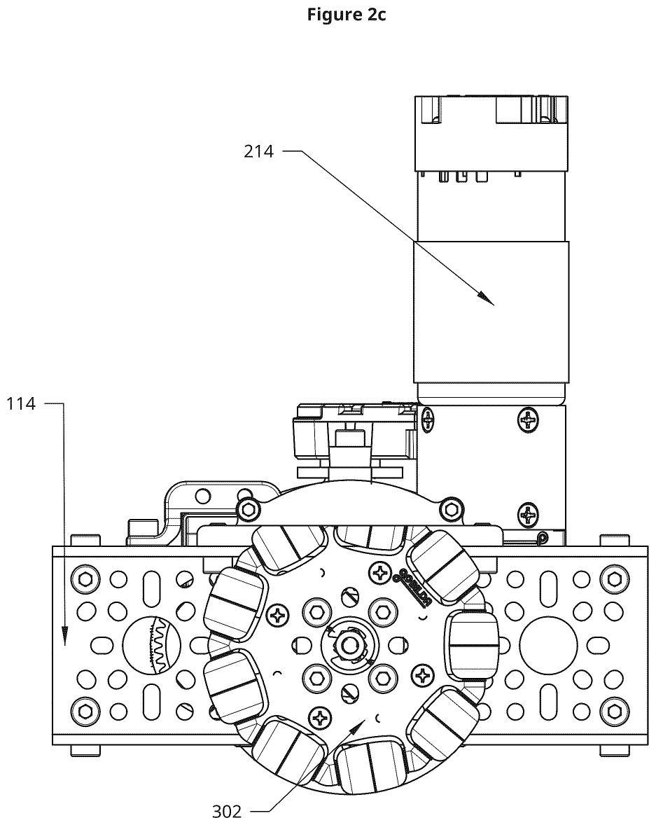

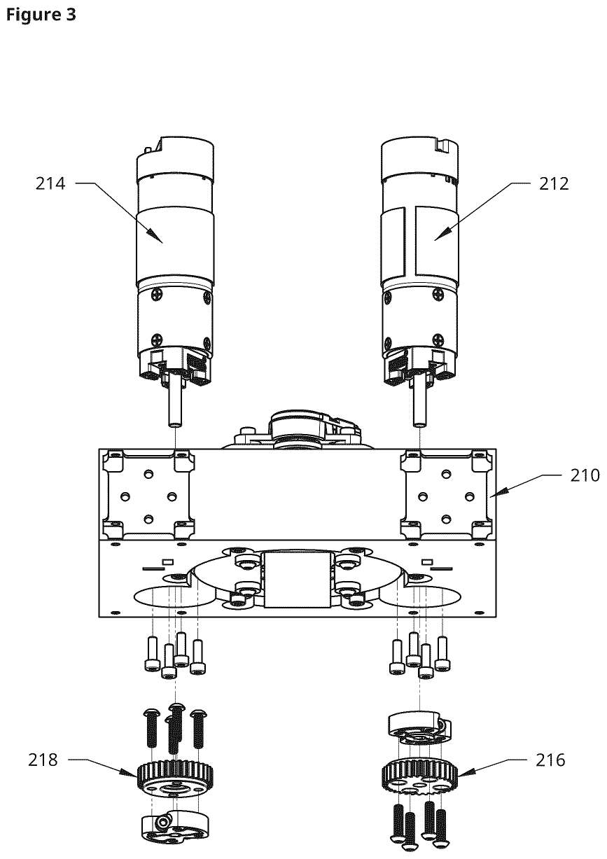

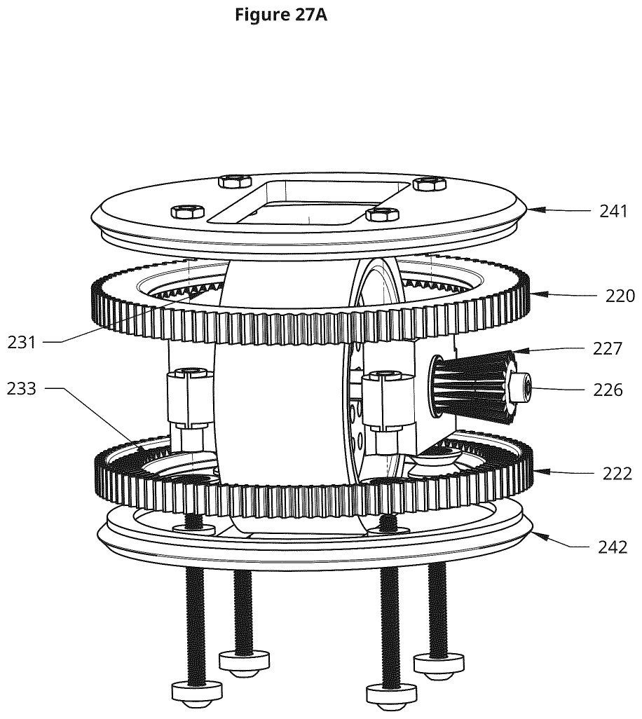

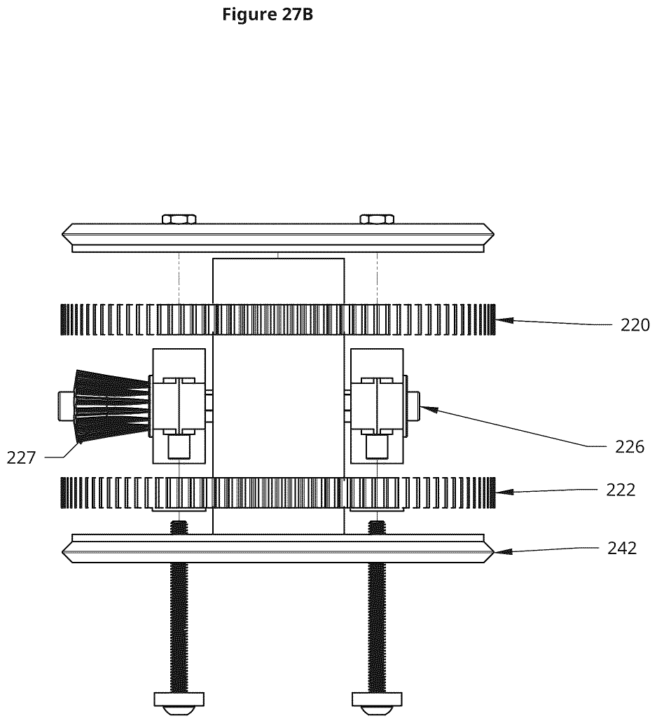

FIGS. 2A-2C and FIGS. 3-4 illustrate an example embodiment of the swerve pod 200. The system includes a differential swerve pod housing 210 (shown in FIG. 3) secured between two chassis plates 112, 114. Two planetary gear motors (M1, M2) 212, 214 are arranged vertically and drive independent spur gears 216, 218. Each spur gear meshes with a corresponding differential gear stage (220 upper, 222 lower) that ultimately drives a high-traction drive wheel 225. As illustrated in FIGS. 27A and 27B, the drive wheel 225 is mounted on an axle 226 with a wheel gear 227 that engages with secondary sprockets on the lower face 231 of the upper differential gear stage 220 and the upper face 233 of the lower differential gear stage 222.

The drive wheel 225 is preferably a 72 mm diameter traction wheel (such as a Rhino wheel) secured to a hex output shaft (not visible). A through-bore magnetic encoder 230 mounted vertically above the drive wheel 225 on a support bracket 232 provides pod-orientation feedback to the control system. The magnetic encoder 230 measures the rotation, and thus the angle, of a wheel case 234 fixedly mounted over the drive wheel 225.

The swerve pod 200 provides a rotatable coupling between the drive wheel 225 and the differential swerve pod housing 210, and thus, the drive wheel 225 may be rotated to substantially any orientation relative to the chassis 110. The drive wheel 225 and differential gear stages 220, 222 are vertically supported by upper and lower pod plates 241, 242 that ride in v-groove bearings 243 mounted to the differential swerve pod housing 210. As illustrated, there are six upper v-groove bearings and six lower v-groove bearings, but different v-groove bearing configurations, including either more or less bearings, are possible. The v-groove bearings are preferably equally spaced around the periphery of the upper and lower pod plates (241, 242).

The orientation and rotation of the drive wheel 225 is controlled by the selective engagement (rotation) of the planetary gear motors. Pod rotation is achieved by commanding planetary gear motors M1 and M2 to rotate in the same direction and at the same speed. Because the upper and lower differential gear trains 220, 222 are mechanically isolated, equal-direction rotation causes the wheel case 234 and drive wheel 225 to yaw without imparting translational ground force. Thus, while the differential swerve pod housing 210 remains substantially still, the drive wheel 225 rotates about a central vertical axis 250. This rotation is measured by the magnetic encoder 230. Wheel rotation is achieved by commanding the planetary gear motors M1 and M2 to rotate in opposite directions and at the same speed. Operating the motors in opposite directions causes the upper and lower differential gear stages 220, 222 to rotate in opposite directions. The wheel axle 226 and the drive wheel 225 are thus driven to rotate, propelling the robot linearly without changing pod heading. Fine-grained blending of the speed and direction of the planetary gear motors M1 and M2 allows for simultaneous rotation of the drive wheel 225 along both its vertical axis 250 and its axle 226.

With only a single ground-contact wheel 225, the robot 100 would be potentially unstable. One option would be to implement a dynamic balancing mechanism, such as those described in U.S. Pat. No. 7,275,607. The inventors have found that a simpler and more reliable approach—which advantageously does not require continuous powering to maintain the robot's stability—is to provide additional group support points located near the outer periphery of the robot 100. FIGS. 2A-2C shows a primary support axis formed by the drive wheel 225 and the two laterally-spaced omni-wheels 300, 302. FIGS. 1B and 1D show roller-ball bearings 260, 262 mounted fore-and-aft on the chassis sides to provide a secondary support axis. The roller-ball bearings may be attached to the chassis using 3D printed mounts. In some embodiments, there may be more than one roller-ball bearing located at each fore location, aft location, or both locations. Together, the roller-ball bearings 260, 262 and the omni-wheels 300, 302 constrain pitch and roll while permitting unrestricted yaw.

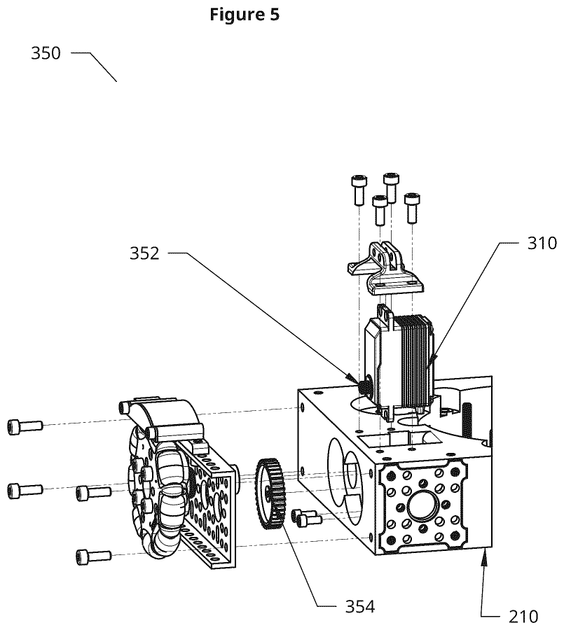

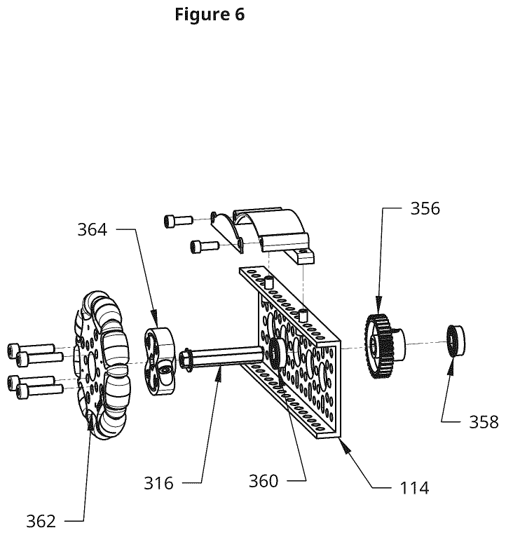

FIGS. 2A-2C further illustrate the two omni-wheel subassemblies. An exemplary single omni-wheel subassembly 350 is illustrated in FIGS. 5 and 6. Each subassembly comprises:
A continuous rotation micro-servo motor 310 with a 25-tooth output spline 352.
A 40-tooth servo gear 354 coupled to the servo axle.
A mating 36-tooth pinion gear 356 mounted to a lateral shaft 316 that spins within a first bearing 358 embedded in the differential swerve pod housing 210 and a second bearing 360 secured in a side chassis plate 114.

In one embodiment, the side chassis plate 114 is a U-channel, and the shaft 316 is a 40 mm hex shaft. Further attached to the lateral shaft 316 is an omni-wheel 362. The omni-wheel 362 may be coupled to the lateral shaft 316 using a hub 364. In one embodiment, the omni-wheel 362 is a 72 mm diameter omni-wheel, and the hub 364 is a sonic hub.

The resulting 40:36 ratio yields a 1.11× speed increase (in revolutions per minute) from servo to omni-wheel, enabling brisk rotational torque about the primary support axis. When the servo gears are disengaged (as described further below), the omni-wheels free-roll, permitting full translational velocity in the lateral direction. Engaging the omni-wheels creates a torque force on the robot about its central vertical axis, allowing for precise control over the yaw of the robot 100. This is helpful because, as will be discussed below, the swerve pod 200 is able to yaw freely within the robot 100 chassis, and thus, the swerve pod 200 is generally unable to rotate the robot 100. Instead, the swerve pod 200 facilitates translational movement of the robot 100 in any direction, irrespective of the robot 100's orientation.

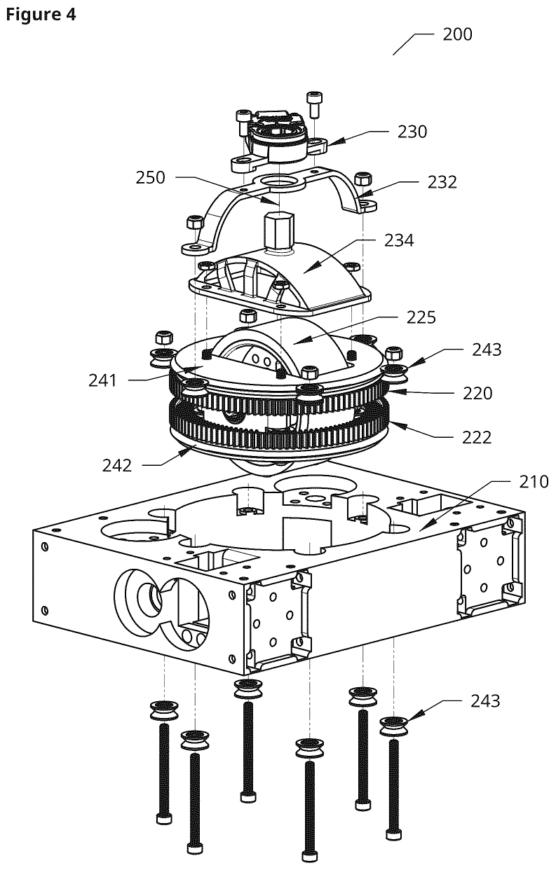

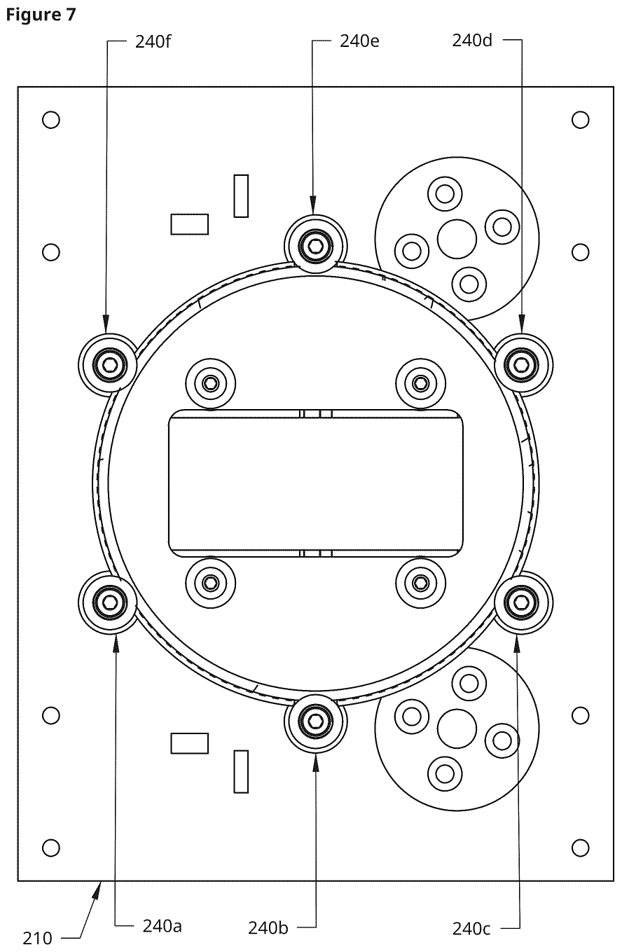

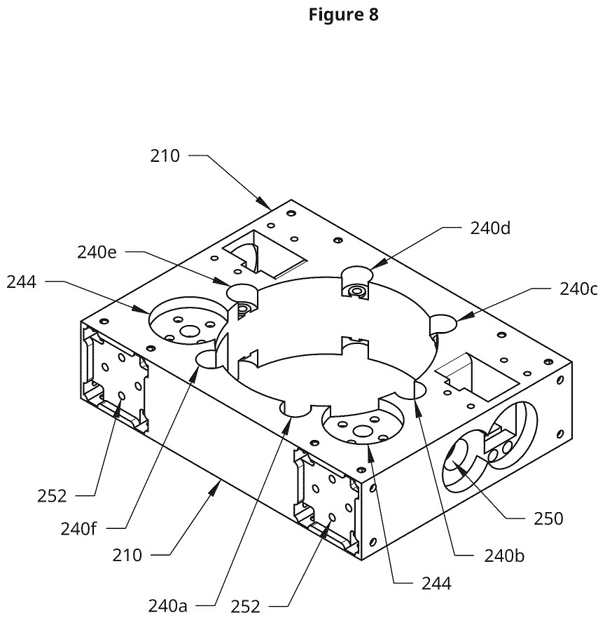

As best seen in FIGS. 7 and 8, the pod housing 210 presents six recesses (240 a-f) on its upper and lower faces which capture upper and lower pod plates via v-groove ball bearings 243 (shown in FIG. 4) to enable smooth pod yaw. The pod housing 210 further includes:
Motor saddles 244 position the gear motors coaxially with the spur gears.
Omni-wheel axle bores 250 centered on the pod mid-plane.
Four mounting flanges 252 (two of them shown) for attaching external chassis rails. In one embodiment, the mounting recesses are quad-block mounting flanges spaced 144 mm apart for direct interface with U-channel rails.

In one embodiment, the overall pod housing 210 footprint is approximately 192 mm×144 mm, allowing easy installation in a compact robotic vehicular design having length, width, and height dimensions of less than approximately 457.2 mm (18 inches).

### Omni-Wheel Disengagement Clutch

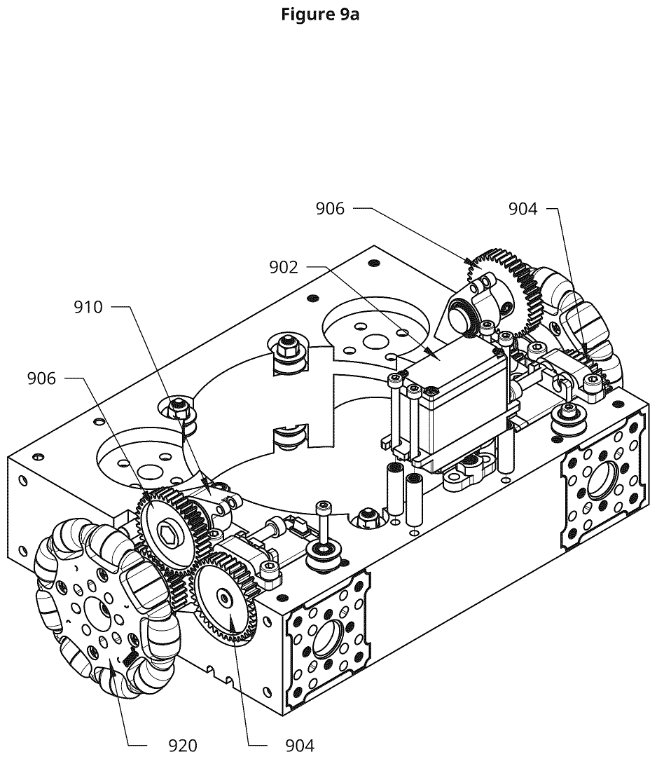

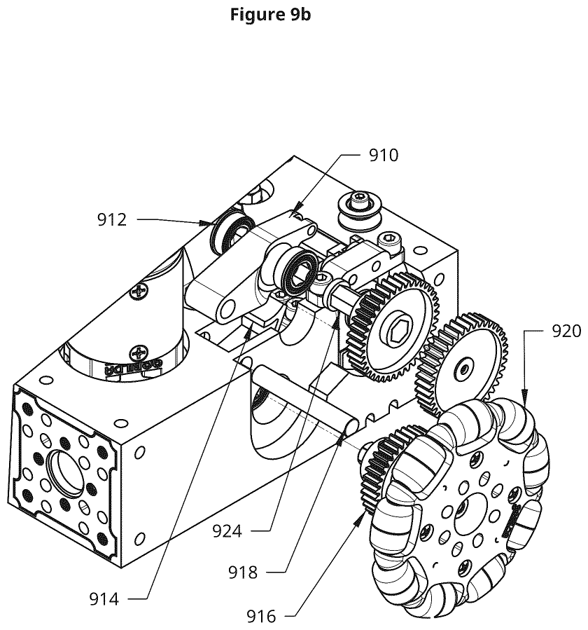

FIGS. 9a-9b illustrate another embodiment, which incorporates a disengageable clutch mechanism into the driveline between a micro-servo motor and its corresponding omni-wheel. A dual-mode servo motor 902 has its output shaft (not shown) coupled to a 40-tooth output gear 904. The output gear 904 enmeshes with a floating intermediate 40-tooth gear 906 mounted on a shaft 924 rotatable within two bearings 912 captured in a 3D printed arm 910. A flexible biasing spring 914 urges the arm 910 upward, creating a small gap between floating intermediate gear 906 and both the output gear 904 and a drive gear 916 mounted on an axle (not shown) with an omni-wheel 920. The arm 910 is controllably pivoted around shaft 918 and against the biasing spring 914 to lower the floating intermediate gear 906 to enmesh with both the output gear 904 and the drive gear 916. This controlled movement may be achieved in a variety of ways. In one embodiment, a tensioning cable (not shown) is tied to the end holes on arm 910. The tensioning cable also couples to a control servo (902) so that rotating the control servo pulls the tensioning cable, urging the arm 910 against the biasing spring 914. Releasing the servo allows the biasing spring 914 to once again urge the arm 910 away from the other drivetrain components. In this way, the omni-wheels 920 are free to rotate about their primary axis, presenting substantially no drag on the robot's free movement.

### Continuous-String Vertical Ladder-Lift Slides

The drive system discussed above, including swerve pod 200 and omni-wheel subassemblies, may be used to provide a controllable drivetrain for a variety of robots and/or vehicles. Additional components may be mounted to a robot 100 to facilitate performing any of a wide variety of tasks. FIG. 1 shows robot 100 equipped with a vertical ladder-lift slide subsystem 400.

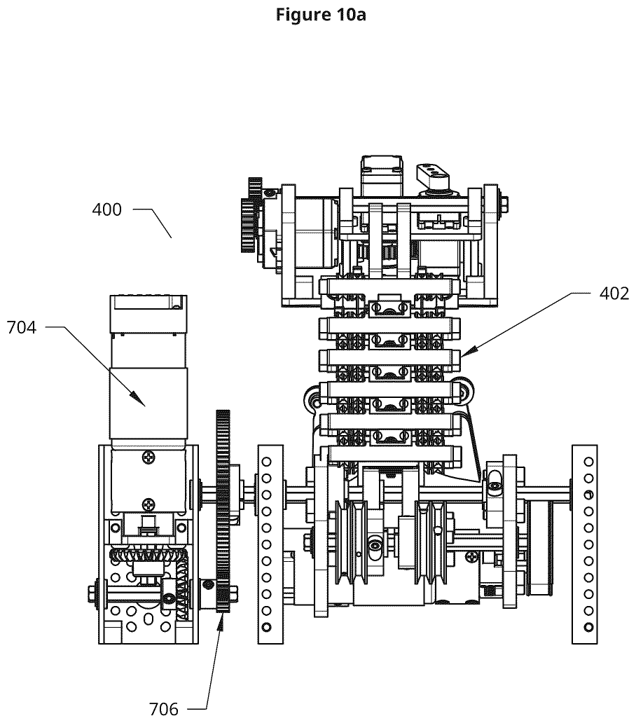

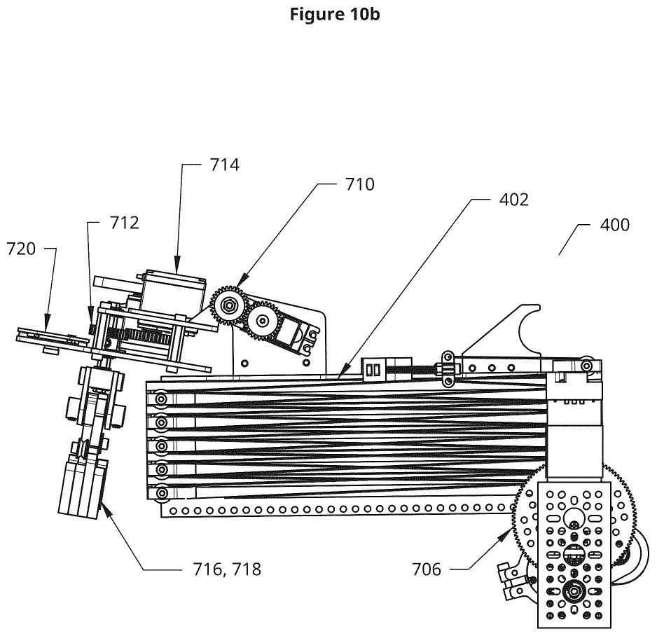

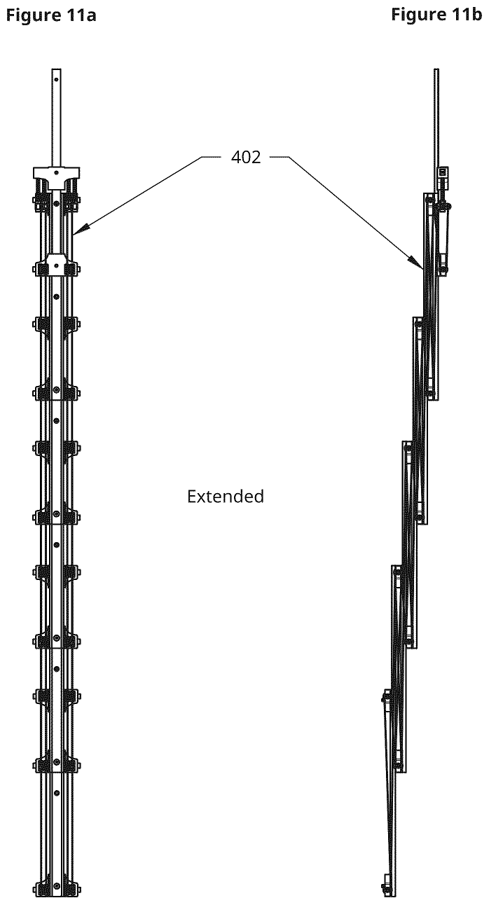

FIG. 10A shows a front view of the vertical ladder-lift slide subsystem 400. FIG. 10B shows a side view of the same. A set of five slide stages 402 are shown in their retracted position. FIG. 11A shows a top view of the slide stages 402 in their extended position. FIG. 11B shows a side view of the slide stages 402 in their extended position.

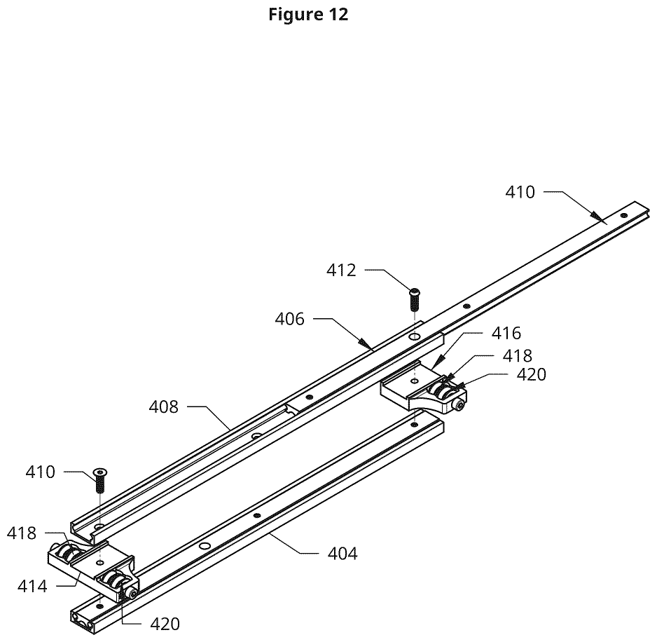

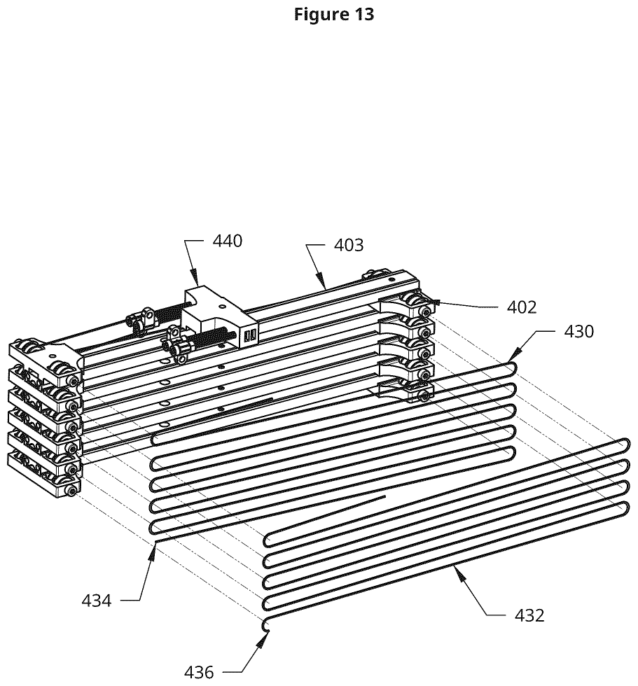

FIG. 12 shows two adjacent slide stages, with a first slide stage 404 retracted and a second slide stage 406 extended. Each slide stage comprises an outer slide rail 408 and an inner slide rail 410. The outer slide rail 408 of the second slide stage 406 is coupled, via a countersunk screw 410 and a button head screw 412, to the first slide stage 404. Between the first slide stage 404 and the second slide stage 406 are two inserts 414, 416. Each insert is equipped with an extension v-groove bearing 418 and a retraction v-groove bearing 420 on each side for a total of four bearings per insert. As shown in FIG. 13, for each side of the stages, an extension string 430 is wound around the series of extension v-groove bearings 418 on each of the stacked slide stages 402. Exerting a pulling force on the extension string 430 at its first end 434 urges together the inserts coupled to opposite ends of adjacent slide stages. Thus, the outer and inner slide rails 408, 410 of each stage are urged linearly apart, causing the overall slide stages 402 to extend toward their extended (or open) configuration. Similarly, a retraction string 436 is wound around the series of retraction v-groove bearings 420 on each of the stacked slide stages 402. At the topmost stage 403, each string 430, 432 is fixedly tied to a string tensioning insert 440 that is affixed to the inner slide rail 410 of the topmost stage 403. Exerting a force on retraction string 436 at its first end 436 urges the inserts coupled to opposite ends of adjacent slide stages together. Thus, the outer and inner slide rails 408, 410 of each stage are urged linearly together, causing the overall slide stages 402 to retract toward their retracted (or closed) configuration. In one embodiment, the slide rails 408, 410 may be Misumi SAR-240 telescopic rails.

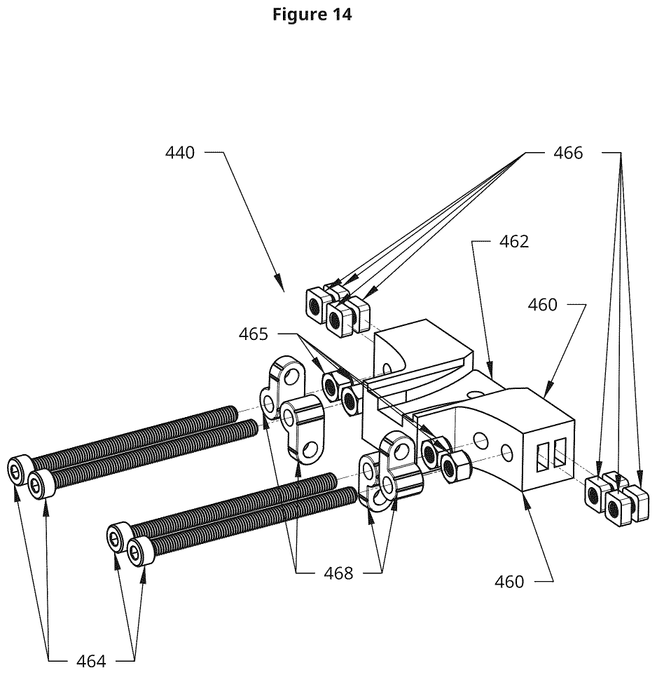

FIG. 14 illustrates additional details of one embodiment of the string tensioning insert 440. The string tensioning insert 440 comprises a tensioning block 460 with a recessed channel 462 for mounting to an inner slide rail. Four tensioning screws 464 each couple to a corresponding pair of square nuts 466 embedded within the tensioning block 460. Mounted on each tensioning screw is a string tie 468 and a locking nut 465. Each of the extension and retraction strings 430, 432 is knotted around a corresponding string tie 468. By rotating the locking nut 465, the distance between the string tie 468 and the end of a slide rail may be adjusted, thereby allowing for individual calibration of the slack or tension of each string 430, 432 for best performance.

FIG. 15 illustrates additional details of one embodiment of insert 414. The insert 414 comprises an insert block 470 with a recessed channel 472 for mounting to an inner or outer slide rail. On either side of the insert block 470, a bolt 474 serves as an axle for a pair of v-groove bearings 476 separated by washers 478. The v-groove bearings 476 allow for both extension and retraction strings to be wound on both sides of the slide stages 402. This arrangement is preferred as it prevents the extension or retraction actions from generating a lateral torque force that may cause the inner and outer slide rails to bind. In other embodiments, only one extension string 434 and one retraction string 432 are provided, and they may be located either together on one side of the slide stages 402 or on opposite sides. With other embodiments, more than two extension strings 434 and two retraction strings 432 may be employed as well.

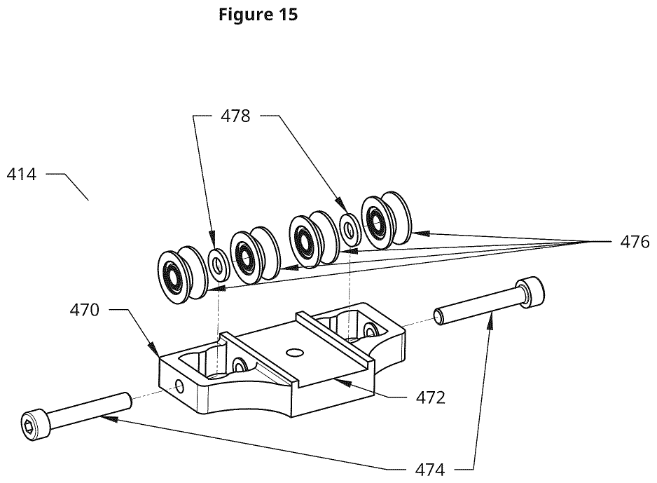

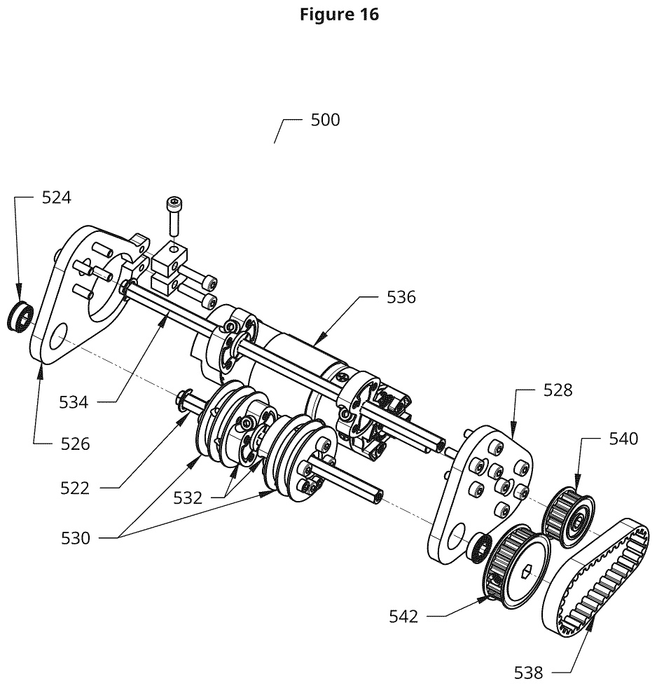

FIG. 16 is a perspective view of the dual-spool drive 500 for pulling the extension and retraction strings 432, 434. A 120 mm shaft 522 is inserted into flanged bearings 524 mounted between two frames 526, 528 that is itself affixed to the rotating arm pivot shaft 534 (discussed further below). Two slim v-groove spools 530 are bolted to hubs 532 and axially keyed to the shaft 522. A planetary motor 536 drives the shaft 522 via a belt 538 running on a 16-tooth drive pulley 540 and 24-tooth driven pulley 542, giving a 3:2 speed reduction. Extension strings (not shown in FIG. 16) are anchored to the inner grooves of the spools 530, and retraction strings 452 to the outer grooves of the spools 530. When the motor 536 turns the spools 530 in one direction, the extension strings are pulled while the retraction strings are let out. When the motor 536 turns the spools 530 in the opposite direction, the extension strings are let out while the retraction strings are pulled. Thus, the extension strings and retraction strings are gathered or released at equivalent rates, ensuring synchronous slide motion and constant string tension.

### Arm, Wrist, and Claw Subsystem

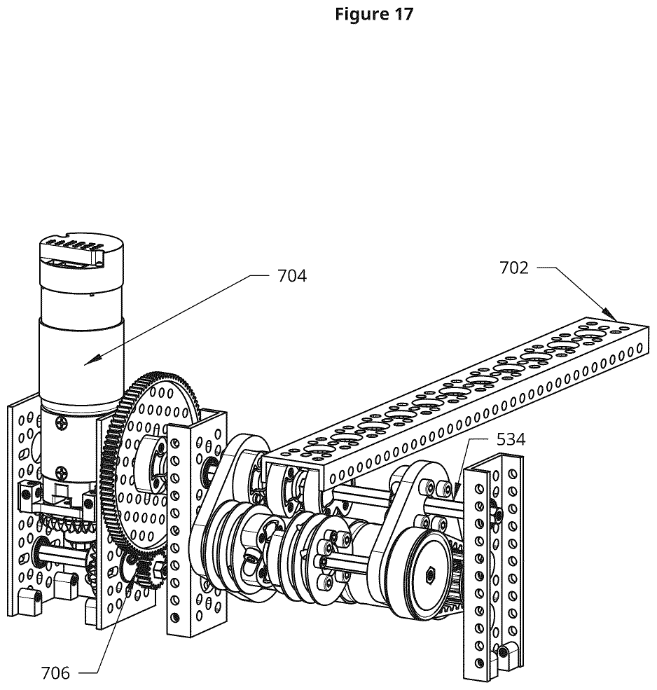

FIG. 17 depicts a main arm 702 affixed to the pivot shaft 534. A motor 704 drives the shaft through a 5:1 spur gear pair 706 (as further illustrated in FIGS. 10a-10b), providing adequate torque to raise the extended slide assembly. A lowest rail of the slide rails 402 is affixed to the arm 702.

A second pivot point 710 at the distal end of the highest slide rail mounts a wrist frame assembly 712. A camera 720 may be attached to the wrist assembly 712 for object location and wrist positioning. The wrist assembly includes a servo motor 714 that actuates the opening and closing of opposing trapezoidal fingers 716, 718. The trapezoidal fingers may be 3D printed or fabricated from layers of clear polycarbonate and are controllably opened and closed to act as a claw for grasping an object (not shown).

### Sideplates, Covers, and Wire Management

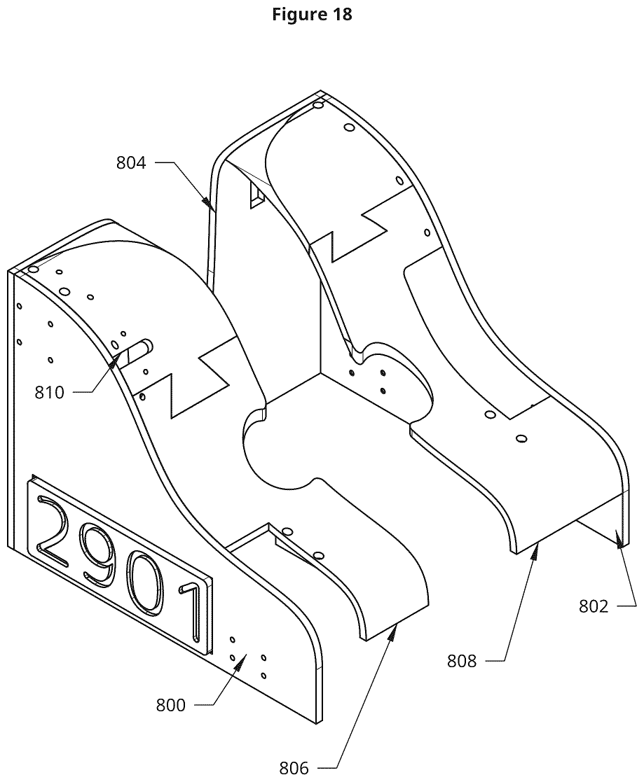

FIG. 18 shows various cover pieces for enclosing components of the robot 100. A first side cover 800 and a second side cover 802 provide smooth side surfaces and protect machinery within the robot 100 from unwanted intrusions. A backplate 804 similarly protects the backside of the robot 100. A first-side top cover 806 and a second-side top cover 808 protect the upper portions of the robot 100. In some embodiments, some or all covers 802-808 may be integrated into a monolithic whole. In other embodiments, the covers 802-808 are each independently mounted to the robot chassis. In still other embodiments, not all the covers (802-808) are present, although in all configurations covers 806 and 808 require 800 and 802 respectively. The second-side top cover 808 preferably has an aperture for a control hub 600 as shown in FIG. 1A. The first-side top cover 806 preferably has a slot 810 to facilitate passing control wires from the interior space of the robot 100 to the wire management extension 812, shown in FIG. 1A. The wire management extension comprises a set of bars interconnected in a scissor lift arrangement. Control wires for powering and controlling components at the end of the vertical ladder-lift slide subsystem 400 a carried in channels that reside in recessions in the scissor lift bars, allowing the wires to passively follow the extension and retraction movement of the ladder-lift slide subsystem 400. The bars are preferably 3D printed from polylactic acid (PLA), while the channels are preferably a cable sleeve. Rotatable joints couple the bars to one another, composed of a bearing and a 3D-printed v-spring. Screw connections or zip ties may be employed to secure control wires within the recesses during extension and retraction of the scissor lift bars. The rotatable joint v-springs are preferably printed from thermoplastic polyurethane (TPU), allowing them to flex significantly and provide a spring-like tensioning that urges the scissor lift toward its collapsed state.

### Control, Vision, and Software Architecture

Robot 100 preferably includes a control hub 600 providing centralized electrical control of its various motors, sensors, and other electrical components. The control hub 600 may facilitate programming of functionality, such as autonomous operation. Manual control of the robot 100 is preferably provided by a wireless communication link to a handheld user control interface. In one embodiment, the handheld user control interface is a Logitech F310 gamepad. Additional details and examples of providing user inputs may be provided to the robot 100 are in U.S. Pat. No. 12,251,627 to Ozaki, et al., which is hereby incorporated in its entirety for all purposes.

An input for controlling movement of the robot 100 relative to the field includes a two-dimensional x-y input as may be provided by a gamepad stick. A two by two rotation matrix is created for the target pod orientation and aligned in the direction of the input vector with the lookAt operation. The target pod rotation matrix is then right-multiplied to the inverse of the chassis rotation matrix, resulting in the target local pod rotation matrix, which is in the robot's internal coordinate system. The chassis rotation matrix represents the orientation of the robot in the field coordinate system, and may be obtained from an IMU device mounted to the chassis such as the control hub 600 or a visual odometry sensor (OTOS). An additional rotation matrix, representing the measured local pod orientation, is defined as the identity matrix and rotated by 0, where 0 represents the heading of the drive wheel 225 in respect to the robot 100's current heading as derived from information provided by the magnetic encoder 230. The target local pod rotation matrix is then right-multiplied to the inverse of the measured local pod rotation matrix, and the result is multiplied by the vector (1,0) to obtain the delta vector. The delta vector is then resolved, through assessment of x and y components, into translational and rotational values of the drive pod that dictate differential speeds for motors M1 and M2. As second input, for example a second gamepad stick input, may be used to control the robot's orientation by selectively engaging the omni-wheel servos. A control loop preferably integrates the orientation changes caused by the omni-wheel servos, relative to the translational movement provided by the swerve drive pod, thereby minimizing translation and angular adjustment errors.

As referenced in the discussion of FIGS. 9A and 9B, the omni-wheels may be selectively coupled to the omni-wheel servo motors. This selective engagement may be substantially automatically controlled by monitoring a power magnitude |P| to the omni-wheel servos. When |P|<threshold ε, the clutch servo is commanded to lift (disengage) the omni-wheels, preventing unnecessary friction. When |P|≥ε, the clutch drops (engages) the wheels. Disengaging the clutch also ensures that the servo motors are not back-driven by movement of the omni-wheels.

### Vision-Guided Object Acquisition

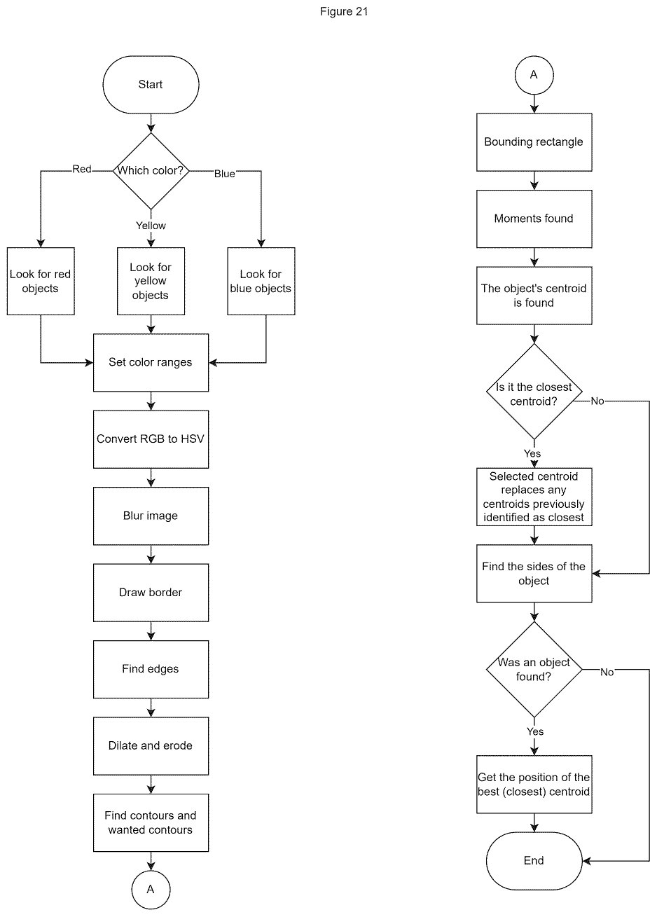

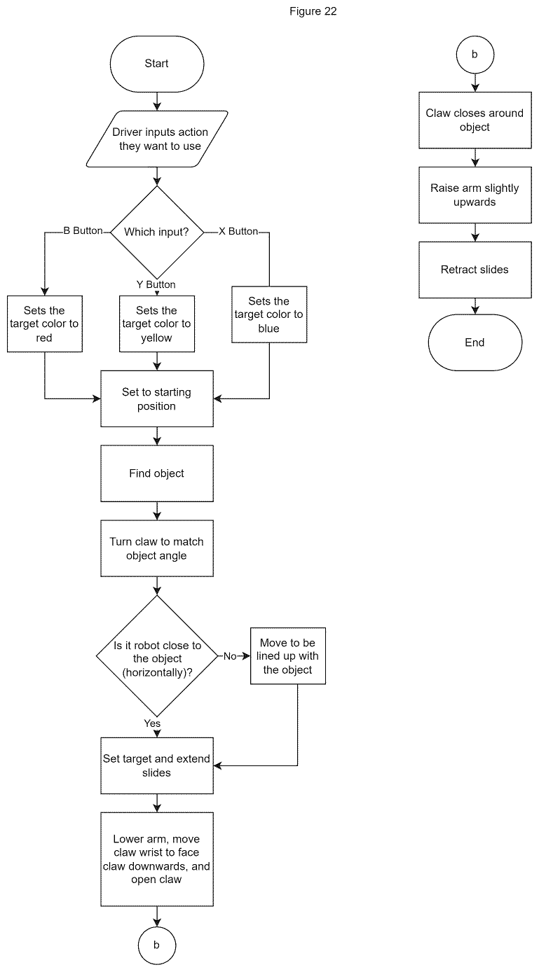

The control hub 600 may incorporate programming to facilitate computer-assisted operation of the vertical ladder-lift slide subsystem 400, articulated arm and wrist assembly 500, and the swerve drive system. A video input to the control hub 600, such as from a web camera, may provide visual information about an area generally in front of the robot 100. There may be various different-colored articles in that area. FIGS. 21 and 22 illustrate example image processing methods for automating control of the robot using such video input data. Upon user selection of a target color (such as via a button input on a gamepad), a processor within control hub 600 may analyze an image from the video input. The image may be resized and converted from RGB to HSV color space. The inventors have found that object detection under variable lighting conditions is more reliable when performed in HSV color space. Noise may be eliminated by blurring the image with a median blur. The image may be modified by drawing a border around its outer edge, which the inventors found improves detection of objects partly located beyond the field of view. An adaptive threshold filter is then applied to outline the edge of each object. Dilation and erosion filters may also be applied to reduce noise and clean up the object edges.

Each object edge is converted to a contour, and a bounding rectangle is calculated that encompasses the contour. If the bounding rectangle is determined to be valid, an image moment is calculated, and from the moment, the size and centroid of the object is estimated based on the number of pixels within the moment. This overall process is repeated for all detected objects.

If multiple objects are detected, then their centroid values are used to estimate which object is closest to the robot 100. The selected object centroid is then used to calculate angular offset from the robot's centerline and a distance to the object. The robot 100's claw is commanded to rotate to an orientation equal to the angular offset +π/2. This orients the claw to a suitable angle for engaging with the object (i.e., picking up the object). If the lateral (left-right) distance to the object exceeds a programmable threshold, the swerve drive subsystem is commanded to maneuver the robot 100 so that the robot 100 is positioned with the object near the robot 100's centerline. The arm is lowered, and the ladder-lift slide subsystem 400 is commanded to extend the linear slides by the distance to the object, thus causing contact between the claw end 550 and the object. The claw is commanded to close, grasping the object between its fingers. The arm is then raised slightly and the ladder-lift slide subsystem 400 is retracted.

The robot 100's location may be estimated by starting at a known location and integrating its movements. This approach, however, is subject to accumulating inaccuracies from small errors over time. The robot 100 may also be equipped with a visual odometry sensor (OTOS), such as that commercially available from Sparkfun.

### Omni-Wheel Rotational Control

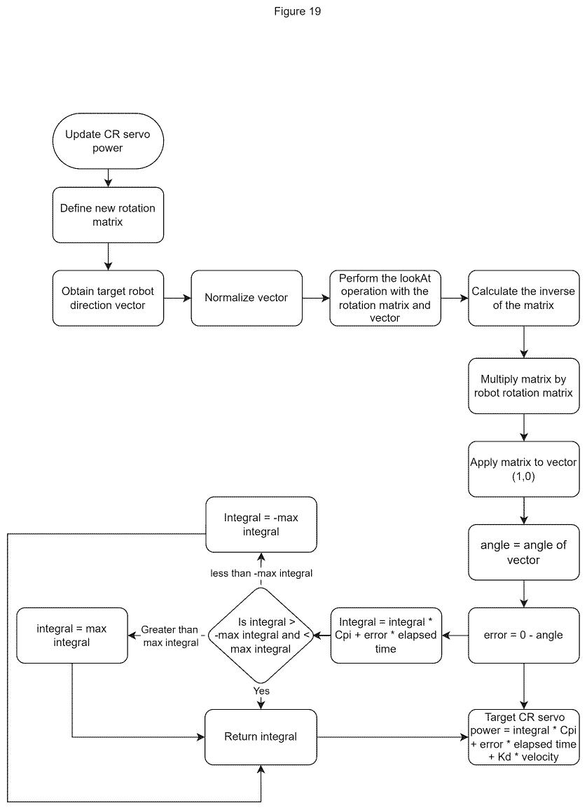

Commands to control the rotation of the two omni-wheel servos may be provided as illustrated in FIG. 19. Firstly, a two by two rotation matrix is defined for the target chassis orientation and assigned to the identity matrix. Then a vector, representing the target chassis orientation obtained through user input, is normalized. The rotation matrix is then pointed in the direction of the target chassis vector through the lookAt operation. The target chassis rotation matrix is then right-multiplied to the inverse of the chassis rotation matrix. The resulting delta rotation matrix is in the robot's internal coordinate system. The delta rotation matrix is then multiplied by the vector (1,0) and the inverse tangent of the result, representing the angle to turn the robot, is fed to a PID loop.

The PID loop calculates the difference between the newly input value and the target position, which provides an error value representative of the angle and distance between the desired orientation and the current orientation. The error is multiplied by a configurable constant value Kp, added to a configurable constant Ki times an integral value, and added to a configurable constant Kd times the error velocity (i.e., change in error divided by change in time) to produce a calculated output power. Finally, the calculated output power value is used to control the speed of the continuous rotation servo motors, if the power value exceeds a configurable threshold.

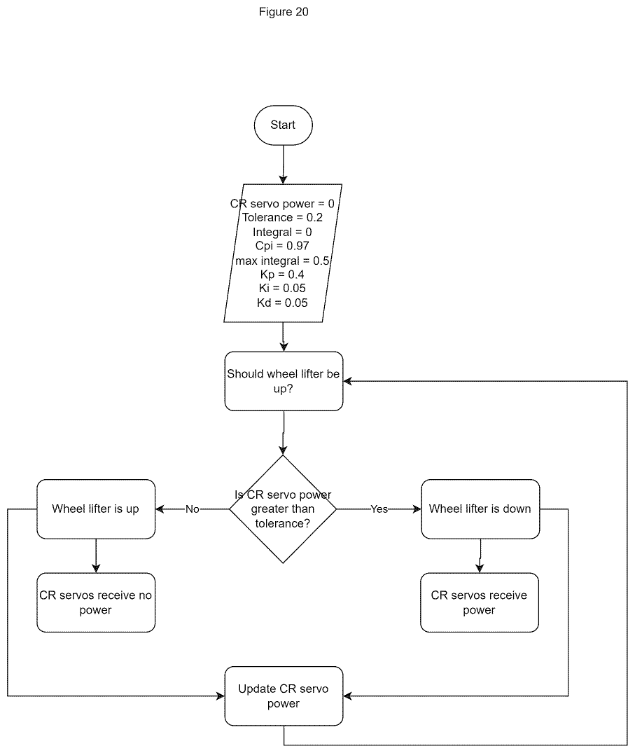

Engagement of the omni-wheel servo motors may be controlled using a process as generally illustrated in FIG. 20. First, the measured and calculated values from the FIG. 19 process are input. These values are then used to determine whether the selectively engageable clutch mechanism between the omni-wheel servo motors and the omni-wheels should be engaged or disengaged. For example, if the calculated output power value exceeds a threshold value, the clutch should be lowered to provide mechanical engagement between the omni-wheel servo motors and the omni-wheels. Alternatively, if the calculated output power value is below the threshold value, the clutch should be raised to disengage the omni-wheel servo motors from the omni-wheels. In that event, the actual output power to the omni-wheel servo motors is also reduced to zero, thereby preventing spurious and wasteful rotation of the omni-wheel servo motors.

### Vertical Linear Slides

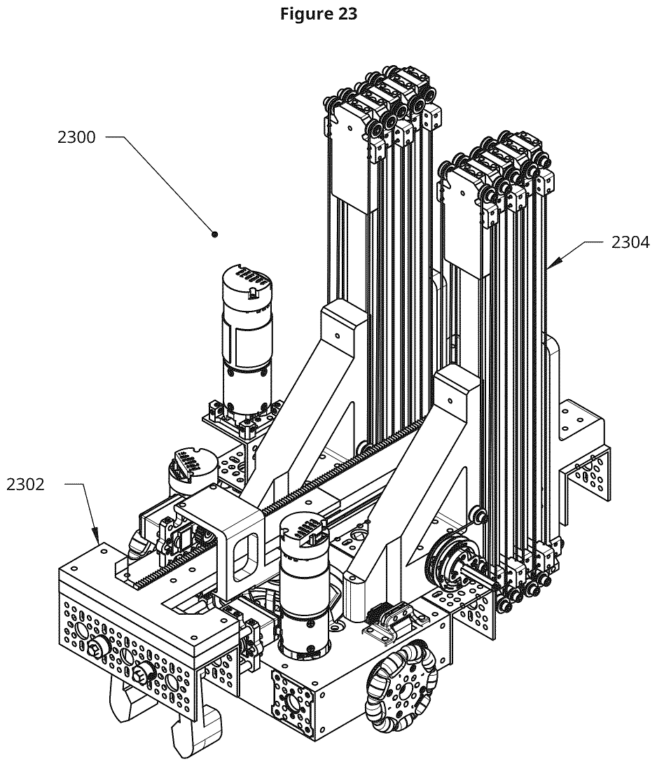

FIG. 23 illustrates an example embodiment of a robot 2300 equipped with a claw arm 2302 mounted to vertical linear slides 2304. The vertical linear slides 2304 may operate similarly to the vertical ladder-lift slide subsystem 400 described previously, however, the vertical linear slides 2304 are mounted in a fixed-vertical orientation. The retraction components are important as to let it reach multiple heights and adjust location even when fully extended.

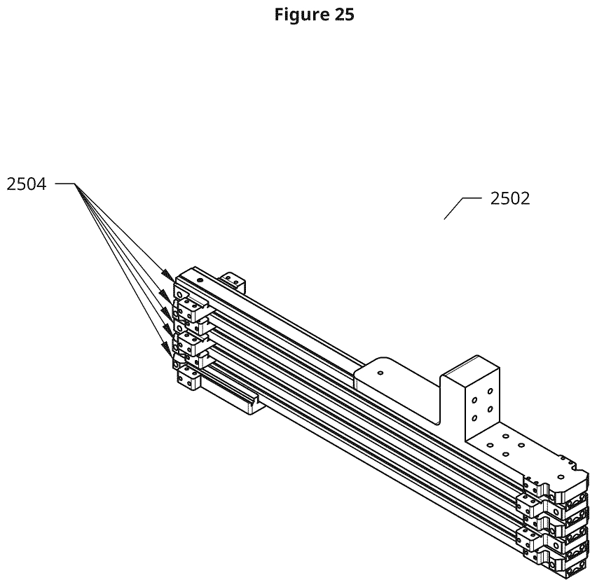

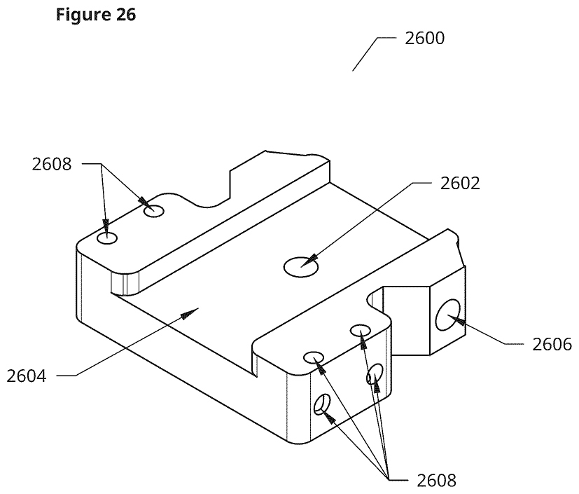

FIG. 25 illustrates an example embodiment of vertical linear slides 2502. Each linear slide 2504 includes an inner slide and outer slide. Mounted between each adjacent pair of linear slides 2504 is an insert 2600, shown in detail in FIG. 26. A through-hole 2602 in the insert facilitates attaching the insert 2600 to a linear slide 2504 with a screw (not shown). The insert 2600 also includes a recessed portion 2604 for aligning the insert 2600 with the linear slide 2504. An axle hole 2606 is provided for an axle (not shown) to which two v-groove bearings (not shown) are rotatably attached, one on either side of the insert 2600. A variety of screw holes 2608 are also provided for affixing an extension string (not shown). An extension string is threaded through the v-groove bearings on each side of the linear slides 2502 in a “ladder lift” manner. Through this method, each linear slide 2504 has one long string that connects to the next slide 2504 through the slide inserts 2600. This allows all the linear slides 2502 to move in unison. This also improves reliability as a slide set can break and the opposite slide set can compensate for it. The use of separate strings at each slide stage also allows for multiple strings to break while retaining some movement functionality for the linear slide overall. Beginning at the top insert, a string is threaded through the top hole 2608 on both sides of the linear insert 2600. The string then connects to the corresponding lower hole 2608 of the lower insert 2600 of the slide 2504 in front of the initial slide. The string then loops back to the original top insert 2600 through the lower hole 2608 on the top insert 2600. Two strings per slide insert 2600 are threaded over a v-groove bearing (not shown) and attach to an adjacent slide insert 2600. The v-groove bearing operates as a mount pulley. Each side of the insert is mirrored which results in two strings per insert 2600. The pattern is repeated for every slide 2504. The extension string is preferably Kevlar string.

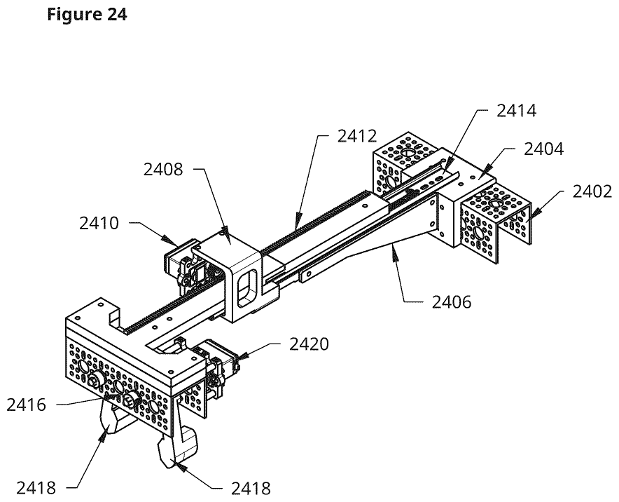

FIG. 24 illustrates an example embodiment of the claw arm 2302. A u-channel base 2402 supports an angle bracket 2404 and horizontal slide support 2406. At the other end of horizontal slide support 2406 is a servo support bracket 2408, to which there is mounted a servo motor 2410. A pinion gear on the servo motor 2410 engages with a rack 2412 extending along the length of a linear slide 2414. Rotation of the servo motor 2410 thus causes the linear slide 2414 to extend or retract. Mounted to an upper, sliding portion of the linear slide 2414 is a claw mechanism 2416. The claw mechanism 2416 includes two pinching fingers 2418 whose movement is controlled by a second servo motor 2420. The design of pinching fingers 2418 may be tailored to improve their gripping capabilities with respect to specific object types. The inventors found that a trapezoidal head configuration of the pinching fingers 2418 to be particularly advantageous.

### Materials and Manufacturing Considerations

The material of various components has been described throughout, but these details are merely exemplary, and any suitable materials may be used. For example, load-bearing components and those potentially subject to friction wear may be steel, stainless steel, aluminum, titanium, other metals, or hard plastic. Printed components may be made from any suitable filament, including PLA, TPU, or Onyx; the infill of printed components may vary from about 20% to about 100%. Shafts may have a circular, D-shaped, or hexagonal cross-section. Some u-channels, linear slides, v-groove bearings, motors, hubs, gears, wheels, screws, shafts, and other components may be commercially available from vendors including goBILDA. For example, shafts may be REX shafts.

The foregoing detailed description is intended to illustrate, not limit, the scope of the inventive concepts. Variations and modifications within the ordinary skill of the robotic systems engineer are contemplated and fall within the teachings of the present disclosure.

1. An omni-directional drive system for a robotic vehicle, the system comprising:
a chassis having a longitudinal axis and a lateral axis;
a single swerve pod disposed substantially at an intersection of the longitudinal and lateral axes, the swerve pod including
(a) a traction wheel rotatable about a first axis generally perpendicular to the chassis, and
(b) a pod housing supporting the traction wheel for rotation about a second axis generally parallel to the chassis so that the traction wheel can be steered to any azimuth relative to the chassis;
a first electric motor coupled to the traction wheel through a first gear train so as to impart driving torque to the traction wheel;
a second electric motor coupled to the pod housing through a second gear train configured cooperatively with the first gear train to differentially rotate the pod housing relative to the traction wheel, thereby steering the traction wheel without interrupting wheel rotation; at least one chassis support element located remotely from the swerve pod and engaging an underlying surface to stabilize the chassis during motion; and
a controller in communication with the first and second electric motors and operable to (i) command a desired heading by rotating the pod housing to a selected azimuth and (ii) command a desired translational velocity by driving the traction wheel, whereby the robotic vehicle is propelled in any horizontal direction using only the single swerve pod.

2. The drive system of claim 1, wherein the traction wheel has a diameter of approximately 72 mm and is mounted on a hexagonal-profile shaft received in bearings carried by the pod housing.

3. The drive system of claim 1, wherein the drive system is mounted to a robot, the robot further comprising a vertical ladder-lift subassembly including at least five linear slides.

4. The drive system of claim 3, wherein the vertical ladder-lift subassembly is mounted to a chassis of the robot via a pivot mount.

5. The drive system of claim 4, wherein the robot further comprises:
a claw affixed to a terminal end of the vertical ladder-lift subassembly,
a motor affixed to the terminal end of the vertical ladder-lift subassembly, for controllably opening and closing the claw,
at least one control wire extending from the motor to a control hub on the chassis of the robot that remains stationary when the vertical ladder-lift subassembly pivots via the pivot mount.

6. The drive system of claim 5, wherein the robot further comprises a passive scissor-lift, wherein the control wire is mounted in a channel on the passive scissor-lift.

7. The drive system of claim 3, wherein the vertical ladder-lift subassembly is fixedly mounted to a chassis of the robot in a vertical orientation.

8. The drive system of claim 7, where the robot further comprises a horizontal claw arm.

9. The drive system of claim 1, further comprising an absolute through-bore encoder coaxially aligned with the second axis and secured to the pod housing for sensing the azimuth of the traction wheel relative to the chassis.

10. The drive system of claim 1, wherein the chassis support element comprises a pair of omni-wheels positioned on opposite sides of the swerve pod and driven by respective continuous-rotation servos to impart controlled rotation of the chassis about the swerve pod.

11. The drive system of claim 7, further comprising a selectively engagable clutch that decouples the omni-wheels from the continuous-rotation servos when the robotic vehicle is translating in a direction parallel to the omni-wheel rollers.

12. The drive system of claim 1, wherein the pod housing is removably attached to the chassis by a plurality of vertical fasteners passing through upper and lower pod plates and retained by v-groove bearings.

13. The drive system of claim 1, wherein the controller executes field-oriented control logic that employs feedback from the through-bore encoder and from a visual odometry sensor to coordinate steering of the pod housing and rotation of the traction wheel.

14. The drive system of claim 1, wherein the first electric motor drives an upper differential spur gear and the second electric motor drives a lower differential spur gear, the upper and lower differential spur gears meshing with a common central spur gear affixed to the traction wheel, thereby effecting simultaneous wheel propulsion and steering.

15. An omni-directional drive system for a robotic vehicle, comprising:
a chassis;
means for supporting a single wheel at a central location on the chassis;
means for rotating the wheel about a first axis to drive the vehicle;
means for steering the wheel about a second axis generally perpendicular to the first axis to select a direction of travel;
means for stabilizing the chassis during motion, the stabilizing means being spaced from the wheel; and
means for controlling the rotating means and the steering means to propel the vehicle in any horizontal direction using only the single wheel.
